(19) United States
(12) Patent Application Publication
(10) Pub. No.: US 2015/0346840 A1
(43) Pub. Date: Dec. 3, 2015

(54) TEETH-MOUNTED, TONGUE-OPERATED KEYBOARD

(71) Applicant: REEM K. ALONAIZI, ALFAIHA (KW)

(72) Inventor: REEM K. ALONAIZI, ALFAIHA (KW)

(21) Appl. No.: 14/289,615

(22) Filed: May 28, 2014

(51) Int. Cl. G06F 3/023; G06F 3/02

(52) U.S. Cl. CPC G06F 3/0233; G06F 3/0202

(57) ABSTRACT

The teeth-mounted, tongue-operated keyboard includes upper and lower teeth mountings that generally conform to the shape of the teeth in a similar manner as teeth-straightening braces. However, unlike braces, the upper and lower mountings contain switches capable of being touch-activated by the user's tongue. The spatial arrangement of the user's teeth provides the required spatial distance enabling the user to selectively touch a given switch mounted on a given tooth. A processor/interpreter has the necessary electronic circuitry to determine which switch was activated and a key map to interpret the meaning of the switch activation.

### BACKGROUND OF THE INVENTION

1. Field of the Invention

The present invention relates to controllers for electronic devices, and particularly to a teeth-mounted, tongue-operated keyboard for alphanumeric data entry used for operating a computer or other electronic system requiring alphanumeric input.

2. Description of the Related Art

A number of input device technologies have been developed to allow individuals to control electronic systems. Examples include eye-tracking systems, the head-mouse, and mouth-operated joysticks. Eye-tracking systems track the gaze direction of the pupils of an individual to control electronic systems, such as computers. However, eye-tracking systems may be prohibitively expensive for most individuals to own for personal use. A head-mouse device tracks the motion of the individual's head in order to move a cursor on a computer screen. However, the head-mouse may be too cumbersome to use due to the size of the device and/or cause undue fatigue because of the muscular effort required to move the device. Moreover, such a system may be useless to individuals who have a limited range of motion. Mouth-operated joysticks can allow an individual to use their mouth or tongue to operate an electronic system, such as a computer. However, a mouth-operated joystick can cause undue fatigue and may not be practical for use by special needs individuals, who may have poor muscle tone and/or control. Yet these special needs individuals still need to have a way to express at least their basic needs, such as hunger, thirst, pain, rest, and the necessity to go to bathroom.

Thus, a teeth-mounted, tongue-operated keyboard solving the aforementioned problems is desired.

### SUMMARY OF THE INVENTION

The teeth-mounted, tongue-operated keyboard includes upper and lower teeth mountings that generally conform to the shape of the teeth in a similar manner as teeth-straightening braces. However, unlike braces, the upper and lower mountings contain switches capable of being touch-activated by the user's tongue. The spatial arrangement of the user's teeth provides the required spatial distance, enabling the user to selectively touch a given switch mounted on a given tooth. A processor/interpreter has the necessary electronic circuitry to determine which switch was activated and a key map to interpret the meaning of the switch activation.

These and other features of the present invention will become readily apparent upon further review of the following specification and drawings.

### BRIEF DESCRIPTION OF THE DRAWINGS

FIG. 1 is an environmental, perspective view of a teeth-mounted, tongue-operated keyboard according to the present invention.

FIG. 2 is a block diagram of the teeth-mounted, tongue-operated keyboard according to the present invention.

FIG. 3 is a plan view showing the upper teeth mounting for the teeth-mounted, tongue-operated keyboard according to the present invention.

FIG. 4 is a plan view showing the lower teeth mounting for the teeth-mounted, tongue-operated keyboard according to the present invention.

FIG. 5 is a plan view showing an alternative embodiment of an upper teeth mounting for the teeth-mounted, tongue-operated keyboard according to the present invention.

FIG. 6 is a plan view showing an alternative embodiment of a lower teeth mounting for the teeth-mounted, tongue-operated keyboard according to the present invention.

Similar reference characters denote corresponding features consistently throughout the attached drawings.

### DETAILED DESCRIPTION OF THE PREFERRED EMBODIMENTS

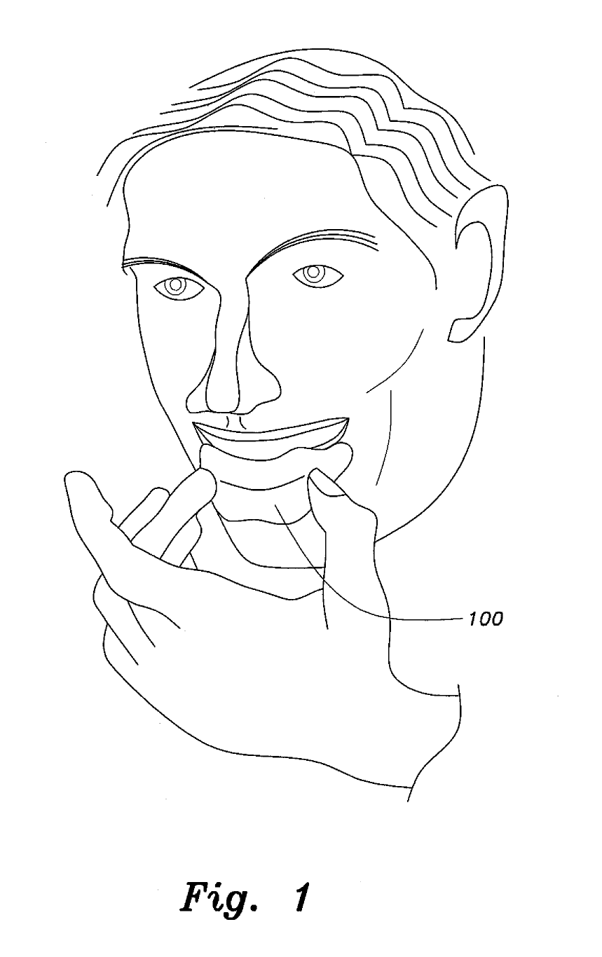

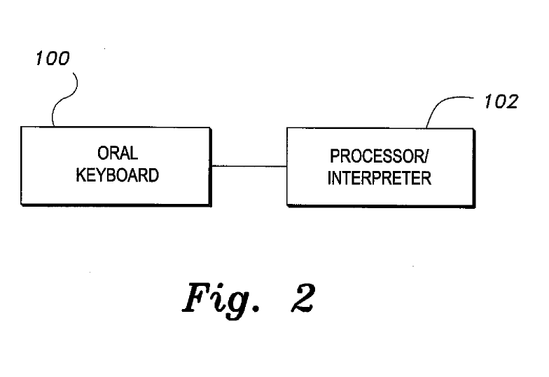

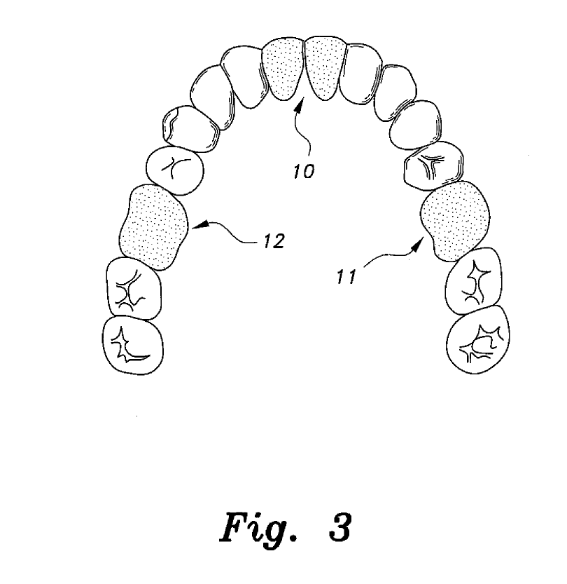

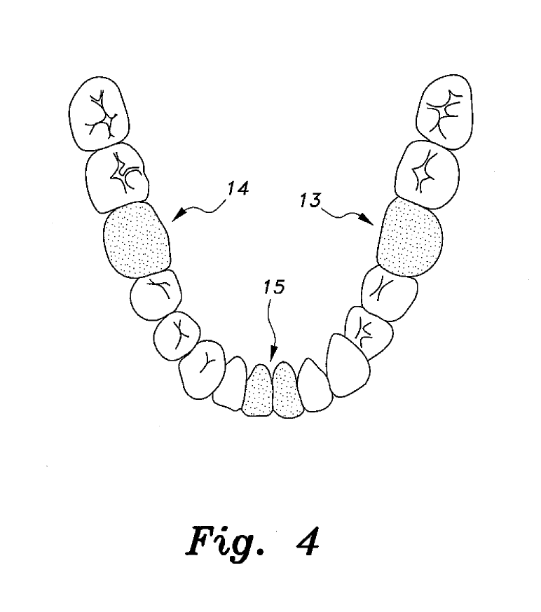

As shown in FIGS. 1, 3, and 4, the teeth mounted, tongue operated keyboard 100 includes upper (FIG. 3) and lower (FIG. 4) teeth mountings that generally conform to the shape of the teeth in a similar manner as teeth-straightening braces. However, unlike braces, the upper and lower mountings contain switches capable of being touch-activated by the user's tongue. The spatial arrangement of the keyboard 100 over the user's teeth provides the required spatial distance, enabling the user to selectively touch a given switch mounted on a given tooth. A processor/interpreter 102 (shown in FIG. 2) is connected to the keyboard 100 and has the necessary electronic circuitry to determine which switch is activated by the user's tongue. The processor/interpreter 102 includes a key map, which the processor/interpreter 102 accesses to interpret the meaning of the switch activation. The key map may be arranged in memory of the processor 102 to simulate the familiar physical key mapping of touch-tone telephones, cellphones, and the like.

Stage one of the present teeth mounted, tongue operated keyboard 100, as shown in FIGS. 3 and 4, is for patients who cannot move or speak and have poor control of their tongues. Thus, as should be noted, the buttons (switches) are widely separated to provide ease and simplicity in the tongue motions required to push the buttons. There are three buttons on the upper teeth mounting and three buttons on the lower teeth mounting. Button number 10 is located on a front upper tooth mount. Button number 11 is located on an upper molar mount, and button number 12 is located on an upper molar mount on the opposite side from button 11. Similarly, for the lower teeth mounting, button number 15 is located on a front lower tooth mount. Button number 13 is located on a lower molar mount, and button number 14 is located on a lower molar mount on the opposite side from button 11. Each button represents one of the basic needs that the patient can communicate using the keyboard 100. The stage-one upper teeth key map is shown in Table 1. The stage-one lower teeth key map is shown in Table 2. The “TBDs” are reserved for custom-programmed mappings deemed necessary by the patient and/or care provider.

TABLE 1
Stage-one upper teeth key map

| BUTTON | FUNCTION |
|---|---|
| 10 | SLEEP |
| 11 | HUNGER |
| 12 | THIRST |

TABLE 2
Stage-one lower teeth key map

| BUTTON | FUNCTION |
|---|---|
| 13 | TBD |
| 14 | TBD |
| 15 | PAIN |

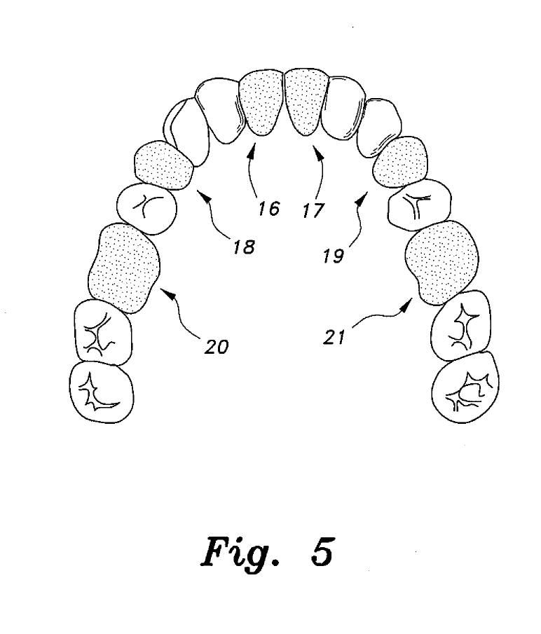

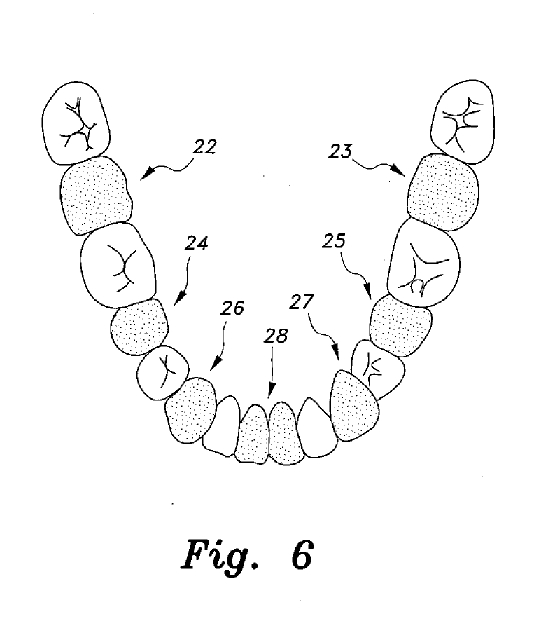

Stage two of the present teeth mounted, tongue operated keyboard 100, as shown in FIGS. 5 and 6, is for patients who cannot move, but they can speak and have easy control of their tongues. Thus, as should be noted, most of the buttons are spaced next to each other to provide a rich communication option (i.e., more tasks) for more able patients. There are six buttons on the upper teeth mounting and seven buttons on the lower teeth mounting. Buttons 16 and 17 are located on adjacent front upper tooth mounts. Buttons 19 and 21 are located on adjacent upper molar mounts, and buttons 18 and 20 are located on adjacent upper molar mounts on the opposite side from buttons 19 and 21. For the lower teeth mounting, button 28 is a mount that fits between the user's two lower front teeth, and is used as a mouse/trackpad pointing control activated when the tongue presses on the button. Buttons 26 and 27 are located on front lower tooth mounts, two teeth away from either side of the pointing control button 28. Buttons 23 and 25 are located on adjacent lower molar mounts, and buttons 22 and 24 are located on adjacent lower molar mounts on the opposite side from buttons 23 and 25. The stage-two upper teeth key map is shown in Table 3. The stage-two lower teeth key map is shown in Table 4.

TABLE 3
Stage-two upper teeth key map

| | | ACTIVATION |
|---|---|---|
| BUTTON | FUNCTION | SEQUENCE |
| 16 | Space/0 | Press/Press And Hold |
| 17 | Delete/Enter | Press/Press And Hold |
| 18 | J/K/L/4 | 1 Press/2 Presses/3 Presses/ |
| | | Press And Hold |
| 19 | G/H/I/3 | 1 Press/2 Presses/3 Presses/ |
| | | Press And Hold |
| 20 | D/E/F/2 | 1 Press/2 Presses/3 Presses/ |
| | | Press And Hold |
| 21 | A/B/C/1 | 1 Press/2 Presses/3 Presses/ |
| | | Press And Hold |

TABLE 4
Stage-two lower teeth key map

| | | ACTIVATION |
|---|---|---|
| BUTTON | FUNCTION | SEQUENCE |
| 22 | Special Character List | Press/Press and Hold |
| | [!@#$%\hat{ }&*( )]/9 | |
| 23 | Shift/Ctrl | Press/Press and Hold |
| 24 | P/Q/R/8 | 1 Press/2 Presses/3 Presses/ |
| | | Press And Hold |
| 25 | M/N/O/7 | 1 Press/2 Presses/3 Presses/ |
| | | Press And Hold |
| 26 | W/X/Y/Z/6 | 1 Press/2 Presses/3 Presses/ |
| | | 4 Presses/ |
| | | Press And Hold |
| 27 | T/U/V/5 | 1 Press/2 Presses/3 Presses/ |
| | | Press And Hold |
| 28 | Pointing/Click | Move Tongue Over |
| | | Surface/Press |

The processor/interpreter 102 includes either a wired or wireless connection adaptable for connecting the teeth-mounted, tongue-operated keyboard 100 to smart devices, such as phones and computers. Upon recognition of the character or function associated with the sequence of pressing the switches, the processor 102 outputs a signal (which may be an ASCII encoded character) that is transmitted, either wirelessly (e.g., by Bluetooth) or by wired connection, to the phone or computer for display, execution, or memory storage on the remote device.

It is to be understood that the present invention is not limited to the embodiments described above, but encompasses any and all embodiments within the scope of the following claims.

1-7. (canceled)

8. An oral operated keyboard, consisting of:
a first mounting conforming to a row of upper teeth in an oral cavity of a user;
a second mounting conforming to a row of lower teeth in the oral cavity of the user;
a plurality of switches disposed in a myriad of positions along each of the first and second mountings, each one of the plurality of switches corresponding to an individual tooth;
a processing device coupled to the plurality of contact switches, the processing device determining which one of the plurality of switches being contacted by a tongue of the user, and the processing device determining a semantic meaning associated with each one of the contacted plurality of switches, the processing device identifying a sequence of tongue-contacts of the switches as a character of the English alphabet from A through Z, the processing device further identifying a sequence of tongue-contacts of the switches as an Arabic numeral from 0 through 9, the processing device also identifying a sequence of tongue-contacts of the switches as a special character selected from the group consisting of !, @, #, $, %, ̂, &, *, (, and), the processing device additionally identifying a sequence of tongue-contacts of the switches as a trackpad key activation, the trackpad key activation being selected from the group consisting of MOVE, POINTER, and SELECT; and
a communication coupling, selected from the group consisting of wired and wireless links, for transmitting a signal corresponding to the identified alphabetic character(s), numeral(s), special characters, and trackpad key activations to a remote electronic device;
wherein the oral operated keyboard is effectively used for communication.

9. An tongue operated keyboard, consisting of:
a first plurality of switches disposed adjacent a row of upper teeth in an oral cavity of a user;
a second plurality of switches disposed adjacent a row of lower teeth in the oral cavity of the user;
wherein each one switch of the first and second plurality of switches corresponding to a respective individual tooth of the user, each switch being selectively contacted by a tongue of the user;
a processing device coupled to the plurality of contact switches, the processing device determining which one of the plurality of switches being selectively contacted by the tongue of the user, and the processing device determining a semantic meaning associated with each one of the contacted plurality of switches;
wherein the processing device consists of:
means for identifying a sequence of tongue-contacts of the switches as a character of the alphabetic characters from A through Z;
means for identifying a sequence of tongue-contacts of the switches as numerals from 0 through 9;
means for identifying a sequence of tongue-contacts of the switches as special characters selected from the group consisting of !, @, #, $, %, A, &, *, (and);
means for identifying a sequence of tongue-contacts of the switches as trackpad key activations, the trackpad key activations being selected from the group consisting of MOVE, POINTER, and SELECT; and
a wired communication coupling for transmitting a signal corresponding to the identified alphabetic characters, numerals, special characters, and trackpad key activations to a remote electronic device.

10. A keyboard for use in association with teeth in the mouth of an individual, the keyboard being teeth-mounted, and tongue-operated, the keyboard consisting of:
an upper mounting dimensioned and configured to conform to an upper row of teeth in the mouth;
a lower mounting dimensioned and configured to conform to a lower row of teeth in the mouth;
a plurality of electrical contact switches, each electrical contact switch selectively disposed in a respective mounting position of each of the upper and lower mountings, associated with a respective tooth in the mouth;
wherein the respective mounting positions of the electrical contact switches are spaced apart along the upper and lower rows of teeth in a range from one to four tooth positions;
wherein each switch of the plurality of electrical contact switches is operatively contacted by the tongue individually, and in accordance with a predefined sequence in order to designate at least one of a plurality of selective specific activations;
a processor/interpreter for receiving the plurality of selective specific activations, the processor/interpreter capable of determining the selected specific activation, and identifying an associated semantic meaning;
wherein the semantic meaning associated with the touched electrical contact switch is selected from the group consisting of SLEEP, HUNGER, THIRST, PAIN, and USER-PROGRAMMABLE-SEMANTIC-MEANING;
the processor/interpreter further being designed and configured to identify a plurality of other activations in accordance with selective predetermined sequences;
wherein the plurality of other activations selectively include:
English alphabet characters from A through Z; Arabic numerals from 0 through 9; a set of special character selected from the group consisting of !, @, #, $, %, ̂, &, *, (, and); and a plurality of trackpad key activations, each of the plurality of trackpad key activations being selected from the group consisting of MOVE, POINTER, and SELECT;
the processor/interpreter further including a transmitter for transmitting a signal corresponding to the semantic meaning, the identified plurality of other activations including the English alphabetic characters, Arabic numerals, the set of special characters, and the plurality of trackpad key activations; and
a remote electronic device operatively coupled to receive the signal transmitted by the processor/interpreter;
wherein the coupling of the remote electronic device is selected from the group consisting of wired and wireless coupling.
